(19) United States
(12) Patent Application Publication
(10) Pub. No.: US 2018/0181323 A1
(43) Pub. Date: Jun. 28, 2018

(54) STORING A PLURALITY OF CONTEXTS IN A SINGLE BAND IN A NON-VOLATILE MEMORY DEVICE

(71) Applicant: INTEL CORPORATION, Santa Clara, CA (US)

(72) Inventors: Jing-Jing LI, Santa Clara, CA (US); Xin GUO, San Jose, CA (US); Brennan A. WATT, Boulder, CO (US); Ye ZHANG, Shanghai (CN)

(21) Appl. No.: 15/391,760

(22) Filed: Dec. 27, 2016

(51) Int. Cl. G06F 3/06

(52) U.S. Cl. CPC G06F 3/0619; G06F 3/0685; G06F 3/0631

(57) ABSTRACT

A first context of a non-volatile memory device is stored starting from a first location of a band of the non-volatile memory device, and an indication is made in a metadata that the first context has been stored starting from the first location of the band. A second context of the non-volatile memory device is stored starting from a second location of the band and an indication is made in the metadata that the second context has been stored starting from the second location of the band.

### BACKGROUND

A solid state drive (SSD) is a data storage device that uses integrated circuit assemblies as non-volatile memory to store data persistently. The SSD may be coupled to a host computing system, such as a personal computer or a server, where the host computing system performs input/output (I/O) operations on the SSD, and where the I/O operations may include writing data to the SSD and reading data from the SSD.

The host computing system provides power to the SSD, and the SSD may undergo a power failure because the host computing system may have failed to provide power to the SSD. In the event of a power failure in the SSD, a backup energy reservoir, such as a capacitor, may allow the SSD to save volatile state information of the SSD by storing the volatile state information persistently in the non-volatile memory of the SSD, prior to the complete shutdown of the SSD.

### BRIEF DESCRIPTION OF THE DRAWINGS

Referring now to the drawings in which like reference numbers represent corresponding parts throughout:

FIG. 1 illustrates a diagram that shows the storing of a single context per context band;

FIG. 2 illustrates a diagram that shows the loading of the latest context in a SSD that stores a single context per context band;

FIG. 3 illustrates a block diagram that shows a SSD in which a plurality of contexts are stored in a single context band, in accordance with certain embodiments;

FIG. 4 illustrates a flowchart that shows how a plurality of contexts are stored in a single context band, in accordance with certain embodiments;

FIG. 5 illustrates a block diagram that shows how a plurality of contexts are stored in a single context band, in accordance with certain embodiments;

FIG. 6 illustrates a block diagram that shows how each of a plurality of context bands store a plurality of contexts, in accordance with certain embodiments;

FIG. 7 illustrates a flowchart that shows how the latest context is loaded, if a plurality of contexts are stored in a single context band, in accordance with certain embodiments;

FIG. 8 illustrates a flowchart that shows how a plurality of contexts are stored in a single context band, and how the latest context is loaded, in accordance with certain embodiments; and

FIG. 9 illustrates a block diagram of a system including a computational device that includes a memory device comprised of non-volatile memory, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

A SSD may store the volatile state information of the SSD at the time of power failure in the non-volatile memory of the SSD, prior to the complete shutdown of the SSD. The volatile state information may include writes sent to the SSD from a host computing system, where the writes have not yet been committed to the non-volatile memory of the SSD. The volatile state information may also include any write that is in progress and as a result is not yet complete. Additionally, volatile state information may also refer to data that has been temporarily buffered or cached in volatile memory of the SSD, acknowledged as written back to a host computing system, but not yet committed to the non-volatile memory of the SSD. Volatile state information may also include data management structures that are stored in volatile memory of the SSD. The volatile state information may also include a logical to physical indirection mapping information that allows a determination of the location of the data of the host computing system in the SSD. In addition to storing the volatile state information during a power failure, the SSD may also store the volatile state information at periodic intervals in the non-volatile memory of the SSD. The volatile state information at a particular instant of time is referred to as the context of the SSD, and the latest context may be used to reboot the SSD to a proper state after a power failure.

A band in a SSD is a collection of contiguous pre-erased erase-blocks in the SSD. A band may be a range of sequential physical memory locations in the non-volatile memory, and a band in a SSD may be referred to as a SSD band. For example, a band may comprise sequential blocks of NAND memory. Each context of the SSD may be stored in a different band of the SSD. For SSDs with large capacities and band sizes, the context saving mechanisms which store one context copy per band may significantly increase the erase amplification factor, leading to degraded endurance for the SSD. At power up (i.e. a reboot), the SSD may need to scan all the bands in the SSD, and compare the band sequence numbers to determine the latest complete context to load. This may cause a large overhead in the time to recover the non-volatile state information.

Certain embodiments provide a new context saving mechanism that stores a plurality of contexts into a single band, instead of storing just a single context into a band. Information regarding the location of each of a plurality of contexts in a single band is recorded in SSD metadata and is used to load the latest complete context, instead of scanning all the bands in a SSD and comparing the band sequence numbers. As a result the SSD endurance is improved and faster booting of the SSD may be performed.

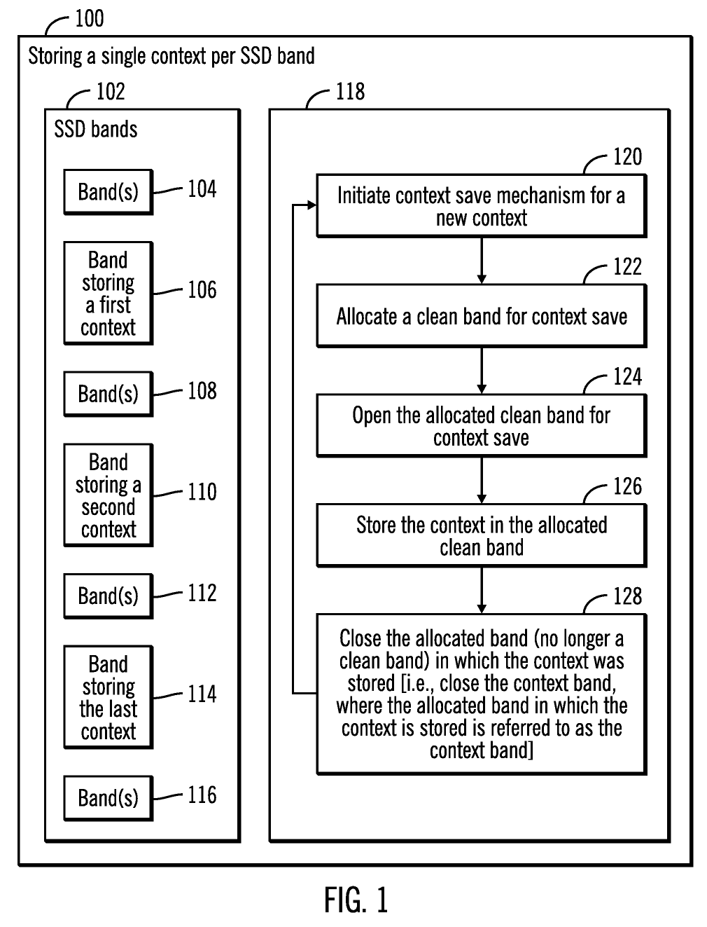

FIG. 1 illustrates a diagram 100 that shows the storing of a single context per SSD band. A plurality of SSD bands 102 are shown in which each of the bands 106, 110, 114 store a single context band, and the other bands 104, 108, 112, 116 do not store any context band. The context bands 106, 110, 114 may be interspersed among the other bands 104, 108, 112, 116.

The mechanism for storing a single context per band is shown via the flowchart 118 in FIG. 1. A context save mechanism for storing a new context is initiated (at block 120). Control proceeds to block 122 in which a clean band is allocated for storing the context. The allocated clean band for the context save is opened (at block 124) and the context is stored (at block 126) in the allocated clean band.

Control proceeds to block 128 in which the allocated band in which the context was stored is closed. It should be noted that after storing the context in the allocated clean band, the allocated clean band is no longer a clean band and may be referred to as a context band. From block 128 control returns to block 120.

Therefore, FIG. 1 shows that when a context save is started, the context saving mechanism first allocates a clean band (i.e., a band that is erased for writing), then opens the allocated clean band, stores the context, and closes the band. This process keeps executing while the SSD is operational. However, this mechanism stores only one context per band, and this necessitates a large number of erases of a large number of bands causing a significant reduction in the life (i.e., endurance) of the SSD. It should be noted that the more the number of erases in a SSD, the greater is the reduction in the lifespan of the SSD.

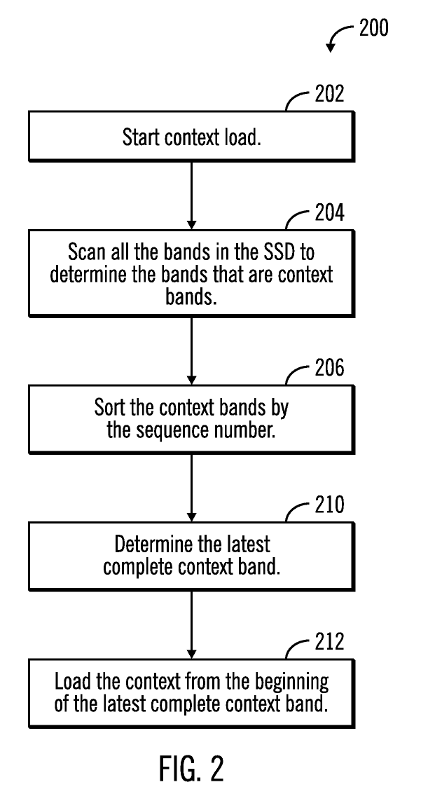

FIG. 2 illustrates a flowchart 200 that shows the loading of the latest context in the mechanism shown in the FIG. 1. The latest context is the last context that is written to a band, and the latest context is loaded while rebooting a SSD after a power loss.

In the flowchart shown in FIG. 2, context load is started (at block 202). All the bands 104, 106, 108, 110, 112, 114, 116 in the SSD are scanned to determine (at block 204) the bands that are context bands. In the example shown earlier in FIG. 1, the determined context bands are the bands shown via reference numerals 106, 110, 114. The context bands 106, 110, 114 are sorted by the sequence number in which the context bands 106, 110, 114 have been written (at block 206), and a determination is made (at block 210) of the latest complete context band 114. The latest complete context band 114 includes the last fully written context. The context is then loaded (at block 212) from the beginning of the latest complete context band 114.

In the mechanisms shown in FIGS. 1 and 2, there may be a large number of context bands. The mechanisms have to scan all the bands in the SSD to determine all the context bands, and sort the sequence numbers of the context bands to determine the latest complete context band. This process is particularly time consuming. As a result, the rebooting process for a SSD may be relatively time consuming.

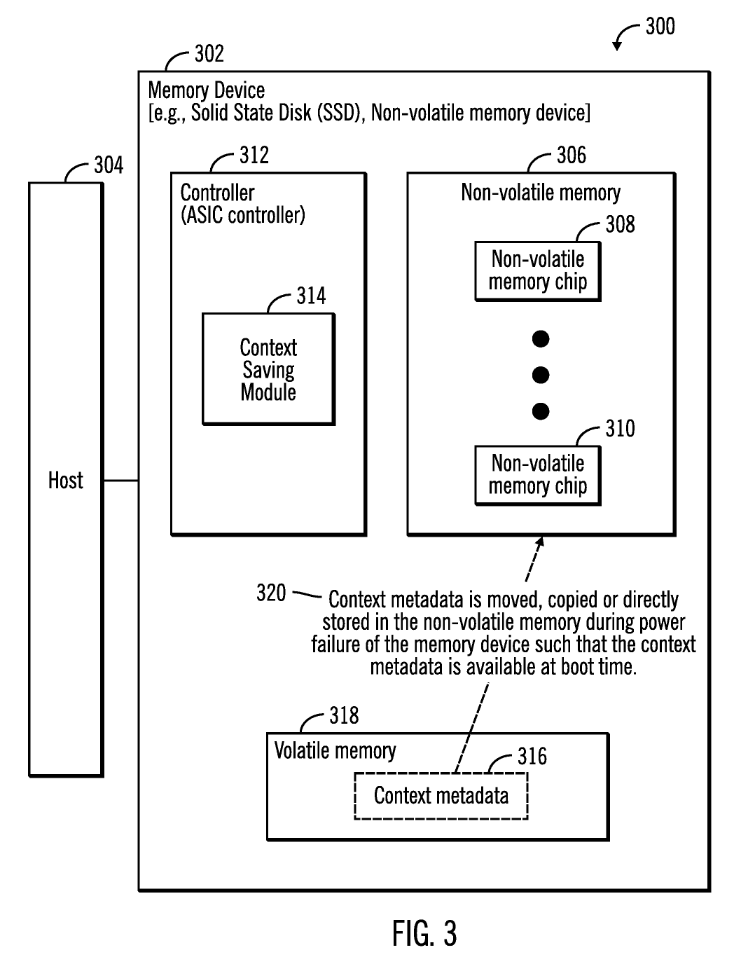

Certain embodiments that are shown in FIGS. 3-9 provide a new context saving mechanism to store a plurality of contexts into a single band, instead of storing just one context per band as shown in FIGS. 1 and 2. As a result SSD endurance is improved and faster booting is performed in comparison to the mechanisms shown in FIGS. 1 and 2.

FIG. 3 illustrates a block diagram 300 that shows a memory device (e.g., a SSD) 302 in which a plurality of contexts are stored in a single band, in accordance with certain embodiments.

The memory device 302 is coupled to a host 304. The memory device 302 may comprise a memory board, a SSD, or any other device that includes non-volatile memory 306. In certain embodiments, the non-volatile memory 306 may be comprised of a plurality of non-volatile memory chips 308, 310. Other configurations of the memory device 302 are possible in alternative embodiments, as long as the memory device 302 includes the non-volatile memory 306.

Although various embodiments are described with respect to a SSD 302, embodiments may be applied to any memory device that comprise non-volatile memory. In one embodiment, the memory device is a block addressable memory device, such as those based on NAND or NOR technologies. A memory device may also include future generation nonvolatile devices, such as a three dimensional crosspoint memory device, or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), magnetoresistive random access memory (MRAM) memory that incorporates memristor technology, or spin transfer torque (STT)-MRAM, a spintronic magnetic junction memory based device, or a combination of any of the above, or other memory. The memory device may refer to the die itself and/or to a packaged memory product.

In certain embodiments, the host 304 may be a computational device (e.g., a laptop computer, a desktop computer, a tablet, a cell phone, a processor, a server, a disk array, or any other suitable computational device), and the memory device 302 may be included inside or may be located outside the host 304.

The memory device 302 may include a controller 312, where the controller 312 may be implemented via an application-specific integrated circuit (ASIC). The controller 312 may include a context saving module 314. The context saving module 314 may update context metadata 316 that comprises information on the locations of a plurality of contexts stored in a single band of the non-volatile memory 306. The context metadata 316 may be maintained in a volatile memory 318 of the memory device 302, while the memory device 302 is operational, and may be moved or copied to the non-volatile memory 306 via a shutdown process that occurs during a power failure of the memory device 302 (as shown via reference numeral 320). In certain embodiments, the context metadata 302 may always be maintained in the non-volatile memory 306. In certain embodiments, the context saving module 314 may be implemented in hardware, firmware, software or any combination thereof.

The memory device 302 may include the volatile memory 318, such as cache, transfer buffers, etc., and some of the data stored in the volatile memory 318 may comprise the context and the context metadata that are stored in the non-volatile memory 306 during a power failure of the memory device 302 or at periodic intervals of time. While the volatile memory 318 has been shown outside of the controller 312, part of the volatile memory 318 may also be located inside the controller 312.

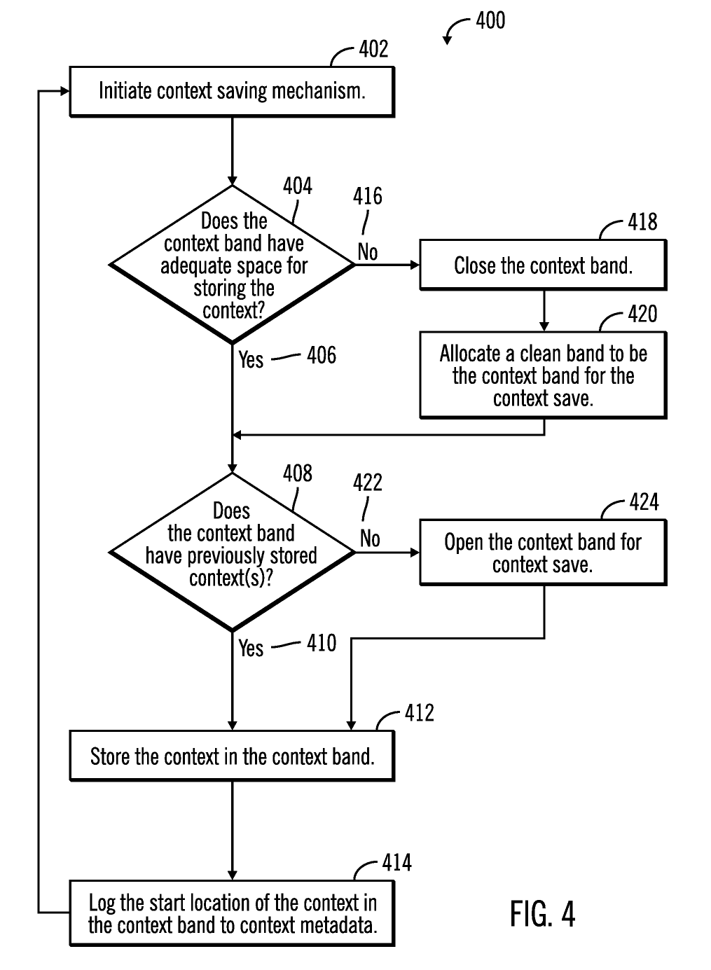

FIG. 4 illustrates a flowchart 400 that shows how a plurality of contexts are stored in a single band, in accordance with certain embodiments. The operations shown in FIG. 4 may be performed within the memory device 302 by the context saving module 314 of the controller 312.

Control starts at block 402 in which a control saving mechanism is initiated. The context saving module 314 determines (at block 404) whether a context band has adequate space for storing the context that needs to be stored. If so (“Yes” branch 406) control proceeds to block 408 in which the control saving module 314 determines whether the context band has one or more previously stored contexts. If so (“Yes” branch 410) control proceeds to block 412 in which the context saving module 314 stores the context in the context band, and logs the start location of the context band to the context metadata 316. The start location may comprise an offset from the beginning location of the context band. From block 414 control returns to block 402 for storing a new context.

If at block 404, the context saving module 314 determines that the context band does not have adequate space for storing the context (“No” branch 416), then control proceeds to block 418 in which the context saving module 314 closes the context band, and allocates (at block 420) a clean band to be the context band for the context save, and control proceeds to block 408.

If at block 408, the context saving module 314 determines that the context band does not have one or more previously stored contexts (“No” branch 422) then control proceeds to block 424 in which the context saving module 314 opens the context band for storing the context, and control proceeds to block 412.

In the embodiments shown in FIG. 4, the context saving mechanism enables the storing of multiple contexts per band. Before closing a context band and allocating a clean band for the context save, the embodiments check if there is enough space left on the context band for another context save. If there is, then the embodiments do not close the current band, but instead proceed to start the new context save on this already open band. If this band has previously stored contexts, the embodiments continue to write on this band. After context save, the embodiments log the start location of the stored context to the context metadata 316 to recover the start location during a context load. It may be noted that at the time of a power failure of the memory device 302 the context metadata 316 is moved or copied to the non-volatile memory 306 or directly stored in the non-volatile memory 306, so the context metadata 316 is available for context load while the memory device 302 is being booted up.

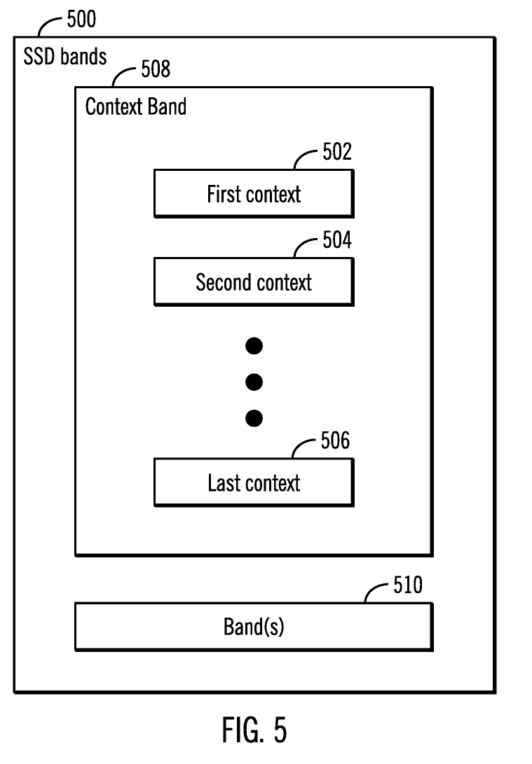

FIG. 5 illustrates a block diagram 500 that shows how a plurality of contexts 502, 504, 506 are stored in a single context band 508, in accordance with certain embodiments shown via the flowchart of FIG. 4. There is a single context band 508 that stores a plurality of contexts 502, 504, 506, and there are other bands 510 besides the single context band 508.

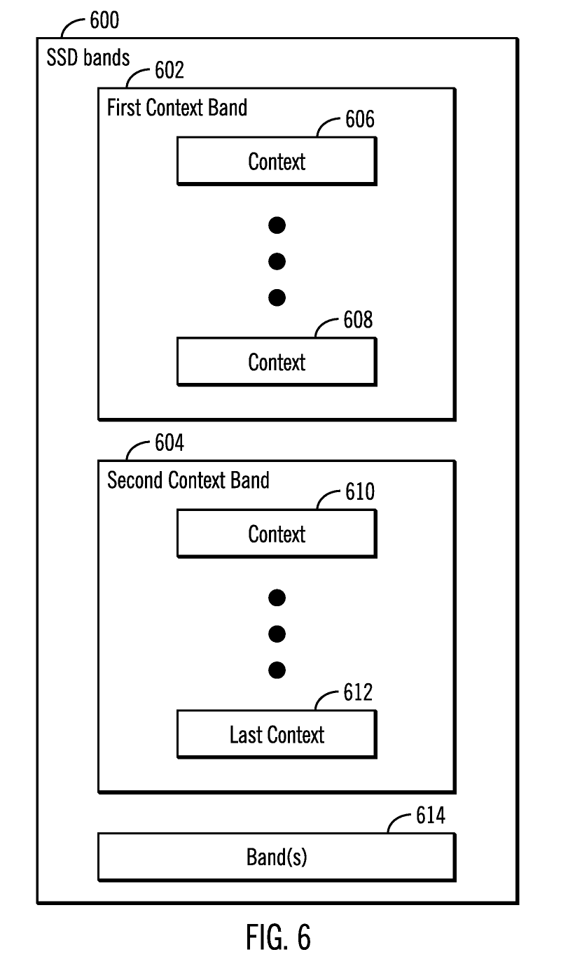

FIG. 6 illustrates a block diagram 600 that shows how each of a plurality of context bands 602, 604 store a plurality of contexts 606, 608, 610, 612, in accordance with certain embodiments shown via the flowchart of FIG. 4. Other bands 614 besides the context bands 602, 604 are also shown.

In FIG. 6, the first context band 602 stores the plurality of contexts 606, 608. When the context band 602 no longer has adequate space two store a new context, the new context is stored in the second context band 604. A plurality of contexts 610, 612 may be stored in the second context band 604, where the last context is shown via reference numeral 612.

While FIG. 6 shows two context bands 602, 604, in certain embodiments, there may be more than two context bands, where each context band may store a plurality of context.

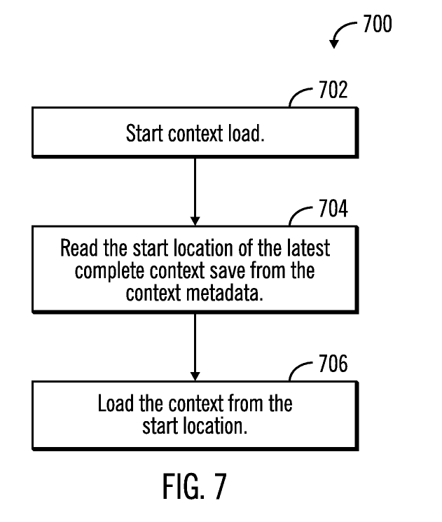

FIG. 7 illustrates a flowchart 700 that shows how the latest context is loaded if a plurality of contexts are stored in a single band, in accordance with certain embodiments. The operations shown in the flowchart 700 may be performed during a rebooting of the memory device 302 after a shutdown of the memory device 302.

Control starts at block 702 in which the context load is started. The start location of the latest complete context save is read (at block 704) from the context metadata 316, and the context is loaded (at block 706) from the start location. Since a plurality of contexts are stored in a context band, the number of context bands are reduced in comparison to the mechanisms shown in FIGS. 1 and 2. Furthermore, as a result of the storing of the location of the latest complete context save in the context metadata 316, the latest context is loaded much faster in comparison to mechanisms in which the context metadata 316 is not maintained. Additionally, by storing a plurality of contexts in a single context band, erase cycles for context bands are reduced and the SSD 302 may have a greater endurance.

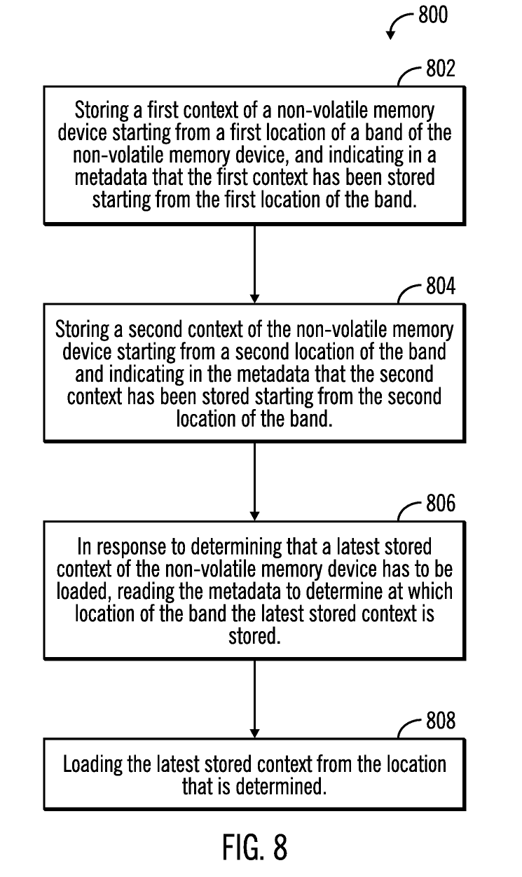

FIG. 8 illustrates a flow chart 800 that shows how a plurality of contexts are stored in a single band and how the latest context is loaded, in accordance with certain embodiments. The operations shown in FIG. 8 may be performed within the memory device 302 by the context saving module 314 of the controller 312.

Control starts at block 802 in which a first context of a non-volatile memory device (e.g., the memory device 302 that may comprise a SSD) is stored starting from a first location of a band of the non-volatile memory device 302, and an indication is made in a metadata 316 that the first context has been stored starting from the first location of the band. Control proceeds to block 804 in which a second context of the non-volatile memory device 302 is stored starting from a second location of the band and an indication is made in the metadata 316 that the second context has been stored starting from the second location of the band.

From block 804 control proceeds to block 806, in which in response to determining that a latest stored context of the non-volatile memory device 302 has to be loaded, the metadata 316 is read to determine at which location of the band the latest stored context is stored. The latest stored context is loaded (at block 808) from the location that is determined.

Therefore FIGS. 3-8 illustrate certain embodiments in which a plurality of contexts are stored per context band of a non-volatile memory device. Boot time of the non-volatile memory device with a latest context is reduced by maintaining a context metadata. Additionally, endurance of the non-volatile memory device is increased by storing a plurality of contexts in a single band in comparison to storing each context in a different band.

The described components and/or operations may be implemented as a method, apparatus or computer program product using standard programming and/or engineering techniques to produce software, firmware, hardware, or any combination thereof. The described operations may be implemented as code maintained in a “computer readable storage medium” for implementation in certain embodiments or for software simulation of a memory chip for design purposes, where a processor may read and execute the code from the computer storage readable medium. The computer readable storage medium includes at least one of electronic circuitry, storage materials, inorganic materials, organic materials, biological materials, a casing, a housing, a coating, and hardware. A computer readable storage medium may comprise, but is not limited to, a magnetic storage medium (e.g., hard drive drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), Solid State Devices (SSD), etc. The code implementing the described operations may further be implemented in hardware logic implemented in a hardware device (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The program code embedded on a computer readable storage medium may be transmitted as transmission signals from a transmitting station or computer to a receiving station or computer. A computer readable storage medium is not comprised solely of transmission signals. Those skilled in the art will recognize that many modifications may be made to this configuration, and that the article of manufacture may comprise suitable information bearing medium known in the art.

Computer program code for carrying out operations for aspects of the certain embodiments may be written in any combination of one or more programming languages. Blocks of flowcharts and/or block diagrams may be implemented by computer program instructions.

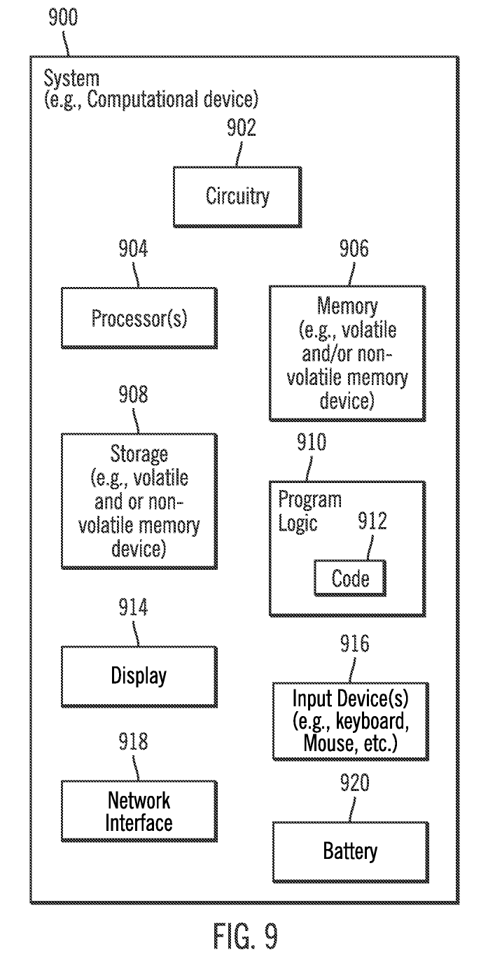

FIG. 9 illustrates a block diagram of a system 900 that may include a computational device where a memory device (designed as per the architecture of the memory device 302 shown in FIG. 3) is included in the computational device. For example, in certain embodiments the system 900 may be a computer (e.g., a laptop computer, a desktop computer, a tablet, a cell phone or any other suitable computational device) that has a memory device (designed as per the architecture of memory device 302 shown in FIG. 3) in the computer. The system 900 may include a circuitry 902 that may in certain embodiments include at least a processor 904. The system 900 may also include a memory 906 (e.g., a memory device 302 as per the architecture shown in FIG. 3), and storage 908 (e.g., e.g., a memory device 302 as per the architecture shown in FIG. 3). The storage 908 may include a solid state drive, a disk drive, or other drives or devices including a non-volatile memory device (e.g., EEPROM, ROM, PROM, flash, firmware, programmable logic, etc.). The storage 908 may also include a magnetic disk drive, an optical disk drive, a tape drive, etc. The storage 908 may comprise an internal storage device, an attached storage device and/or a network accessible storage device. The system 900 may include a program logic 910 including code 912 that may be loaded into the memory 906 and executed by the processor 904 or circuitry 902. In certain embodiments, the program logic 910 including code 912 may be stored in the storage 908. In certain other embodiments, the program logic 910 may be implemented in the circuitry 902. Therefore, while FIG. 9 shows the program logic 910 separately from the other elements, the program logic 910 may be implemented in the memory 906 and/or the circuitry 902. The system 900 may also include a display 914 (e.g., an liquid crystal display (LCD), a light emitting diode (LED) display, a cathode ray tube (CRT) display, a touchscreen display, or any other suitable display). The system 900 may also include one or more input devices 916, such as, a keyboard, a mouse, a joystick, a trackpad, or any other suitable input devices. In certain embodiments, the display 914 may be coupled to a memory device comprising the storage 908 and/or the memory 906; a network interface 918 may be communicatively coupled to the processor 904; and a battery 920 may be communicatively coupled to the processor 904. Other components or devices beyond those shown in FIG. 9 may also be found in the system 900.

Certain embodiments may be directed to a method for deploying computing instruction by a person or automated processing integrating computer-readable code into a computing system, wherein the code in combination with the computing system is enabled to perform the operations of the described embodiments.

The terms “an embodiment”, “embodiment”, “embodiments”, “the embodiment”, “the embodiments”, “one or more embodiments”, “some embodiments”, and “one embodiment” mean “one or more (but not all) embodiments” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

At least certain operations that may have been illustrated in the figures show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to be limited to the precise forms disclosed. Many modifications and variations are possible in light of the above teaching.

### Examples

The following examples pertain to further embodiments.

Example 1 is a method for managing contexts in which a first context of a non-volatile memory device is stored starting from a first location of a band of the non-volatile memory device, and an indication is made in a metadata that the first context has been stored starting from the first location of the band. A second context of the non-volatile memory device is stored starting from a second location of the band and an indication is made in the metadata that the second context has been stored starting from the second location of the band.

In example 2, the subject matter of example 1 may include that in response to determining that a latest stored context of the non-volatile memory device has to be loaded, reading the metadata to determine at which location of the band the latest stored context is stored; and loading the latest stored context from the location that is determined.

In example 3, the subject matter of example 2 may include that the latest stored context is the second context.

In example 4, the subject matter of example 1 may include that the first context comprises a volatile state information of the non-volatile memory device at a first instant of time, and wherein the second context comprises the volatile state information of the non-volatile memory device at a second instant of time.

In example 5, the subject matter of example 1 may include that the band is a first context band, wherein a plurality of contexts are stored in the first context band, the method further comprising: in response to determining that the first context band does not have adequate space to store a new context, opening a new context band and storing the new context in the new context band.

In example 6, the subject matter of example 1 may include that boot time of the non-volatile memory device is reduced by maintaining a context metadata that indicates a location of a latest context, in comparison to not maintaining the context metadata.

In example 7, the subject matter of example 1 may include that the endurance of the non-volatile memory device is increased by storing a plurality of contexts in a single band in comparison to storing each context in a different band.

Example 8 is a memory device for managing contexts, the memory device comprising: a non-volatile memory; and a controller coupled to the non-volatile memory, wherein the controller is configurable to: store a first context starting from a first location of a band, and indicate in a metadata that the first context has been stored starting from the first location of the band; and store a second context starting from a second location of the band and indicate in the metadata that the second context has been stored starting from the second location of the band.

In example 9, the subject matter of example 8 may include that the controller is further configurable to: in response to determining that a latest stored context has to be loaded, read the metadata to determine at which location of the band the latest stored context is stored; and load the latest stored context from the location that is determined.

In example 10, the subject matter of example 9 may include that the latest stored context is the second context.

In example 11, the subject matter of example 8 may include that the first context comprises a volatile state information of the non-volatile memory device at a first instant of time, and wherein the second context comprises the volatile state information of the non-volatile memory device at a second instant of time.

In example 12, the subject matter of example 8 may include that the band is a first context band, wherein a plurality of contexts are stored in the first context band, the method further comprising: in response to determining that the first context band does not have adequate space to store a new context, opening a new context band and storing the new context in the new context band.

In example 13, the subject matter of example 8 may include that boot time of the non-volatile memory device is reduced by maintaining a context metadata that indicates a location of a latest context, in comparison to not maintaining the context metadata.

In example 14, the subject matter of example 8 may include that the endurance of the non-volatile memory device is increased by storing a plurality of contexts in a single band in comparison to storing each context in a different band.

Example 15 is a computational device for managing contexts, the computational device comprising: a processor; and a memory device coupled to the processor, the memory device comprising: a non-volatile memory; and a controller coupled to the non-volatile memory, wherein the controller is configurable to: store a first context starting from a first location of a band, and indicate in a metadata that the first context has been stored starting from the first location of the band; and store a second context starting from a second location of the band and indicate in the metadata that the second context has been stored starting from the second location of the band.

In example 16, the subject matter of example 15 may include that the controller is further configurable to: in response to determining that a latest stored context has to be loaded, read the metadata to determine at which location of the band the latest stored context is stored; and load the latest stored context from the location that is determined.

In example 17, the subject matter of example 16 may include that the latest stored context is the second context.

In example 18, the subject matter of example 15 may include that the first context comprises a volatile state information of the non-volatile memory device at a first instant of time, and wherein the second context comprises the volatile state information of the non-volatile memory device at a second instant of time.

In example 19, the subject matter of example 15 may include that the band is a first context band, wherein a plurality of contexts are stored in the first context band, the method further comprising: in response to determining that the first context band does not have adequate space to store a new context, opening a new context band and storing the new context in the new context band.

In example 20, the subject matter of example 15 may include that boot time of the non-volatile memory device is reduced by maintaining a context metadata that indicates a location of a latest context, in comparison to not maintaining the context metadata.

In example 21, the subject matter of example 15 may include that the endurance of the non-volatile memory device is increased by storing a plurality of contexts in a single band in comparison to storing each context in a different band.

Example 22 is a computational device for managing contexts, the computational device comprising: a processor; a display communicatively coupled to the processor; a network interface communicatively coupled to the processor; and a memory device coupled to the processor, the memory device comprising: a non-volatile memory; and a controller coupled to the non-volatile memory, wherein the controller is configurable to: store a first context starting from a first location of a band, and indicate in a metadata that the first context has been stored starting from the first location of the band; and store a second context starting from a second location of the band and indicate in the metadata that the second context has been stored starting from the second location of the band.

In example 23, the subject matter of example 22 may include that the controller is further configurable to: in response to determining that a latest stored context has to be loaded, read the metadata to determine at which location of the band the latest stored context is stored; and load the latest stored context from the location that is determined.

In example 24, the subject matter of example 23 may include that the latest stored context is the second context.

In example 25, the subject matter of example 22 may include that the first context comprises a volatile state information of the non-volatile memory device at a first instant of time, and wherein the second context comprises the volatile state information of the non-volatile memory device at a second instant of time.

Example 26 is a system for managing contexts, the system comprising: means for storing a first context of a non-volatile memory device starting from a first location of a band of the non-volatile memory device, and indicating in a metadata that the first context has been stored starting from the first location of the band; and means for storing a second context of the non-volatile memory device starting from a second location of the band and indicating in the metadata that the second context has been stored starting from the second location of the band.

All optional features of any of the systems and/or apparatus described above may also be implemented with respect to the method or process described above, and specifics in the examples may be used anywhere in one or more embodiments. Additionally, all optional features of the method or process described above may also be implemented with respect to any of the system and/or apparatus described above, and specifics in the examples may be used anywhere in one or more embodiments.

What is claimed is:

1. A method, comprising:
storing a first context of a non-volatile memory device starting from a first location of a band of the non-volatile memory device, and indicating in a metadata that the first context has been stored starting from the first location of the band; and
storing a second context of the non-volatile memory device starting from a second location of the band and indicating in the metadata that the second context has been stored starting from the second location of the band.

2. The method of claim 1, the method further comprising:
in response to determining that a latest stored context of the non-volatile memory device has to be loaded, reading the metadata to determine at which location of the band the latest stored context is stored; and
loading the latest stored context from the location that is determined.

3. The method of claim 2, wherein the latest stored context is the second context.

4. The method of claim 1, wherein the first context comprises a volatile state information of the non-volatile memory device at a first instant of time, and wherein the second context comprises the volatile state information of the non-volatile memory device at a second instant of time.

5. The method of claim 1, wherein the band is a first context band, and wherein a plurality of contexts are stored in the first context band, the method further comprising:
in response to determining that the first context band does not have adequate space to store a new context, opening a new context band and storing the new context in the new context band.

6. The method of claim 1, wherein boot time of the non-volatile memory device is reduced by maintaining a context metadata that indicates a location of a latest context, in comparison to not maintaining the context metadata.

7. The method of claim 1, wherein endurance of the non-volatile memory device is increased by storing a plurality of contexts in a single band in comparison to storing each context in a different band.

8. A memory device, comprising:
a non-volatile memory; and
a controller coupled to the non-volatile memory, wherein the controller is configurable to:
store a first context starting from a first location of a band, and indicate in a metadata that the first context has been stored starting from the first location of the band; and
store a second context starting from a second location of the band and indicate in the metadata that the second context has been stored starting from the second location of the band.

9. The memory device of claim 8, wherein the controller is further configurable to:
in response to determining that a latest stored context has to be loaded, read the metadata to determine at which location of the band the latest stored context is stored; and
load the latest stored context from the location that is determined.

10. The memory device of claim 9, wherein the latest stored context is the second context.

11. The memory device of claim 8, wherein the first context comprises a volatile state information at a first instant of time, and wherein the second context comprises the volatile state information at a second instant of time.

12. The memory device of claim 8, wherein the band is a first context band, and wherein a plurality of contexts are stored in the first context band, wherein the controller is further configurable to:
in response to determining that the first context band does not have adequate space to store a new context, open a new context band and storing the new context in the new context band.

13. The memory device of claim 8, wherein boot time of the memory device is reduced by maintaining a context metadata that indicates a location of a latest context, in comparison to not maintaining the context metadata.

14. The memory device of claim 8, wherein endurance of the memory device is increased by storing a plurality of contexts in a single band in comparison to storing each context in a different band.

15. A computational device, comprising:
a processor; and
a memory device coupled to the processor, the memory device comprising:
a non-volatile memory; and
a controller coupled to the non-volatile memory, wherein the controller is configurable to:
store a first context starting from a first location of a band, and indicate in a metadata that the first context has been stored starting from the first location of the band; and
store a second context starting from a second location of the band and indicate in the metadata that the second context has been stored starting from the second location of the band.

16. The computational device of claim 15, wherein the controller is further configurable to:
in response to determining that a latest stored context has to be loaded, read the metadata to determine at which location of the band the latest stored context is stored; and
load the latest stored context from the location that is determined.

17. The computational device of claim 16, wherein the latest stored context is the second context.

18. The computational device of claim 15, wherein the first context comprises a volatile state information at a first instant of time, and wherein the second context comprises the volatile state information at a second instant of time.

19. The computational device of claim 15, wherein the band is a first context band, and wherein a plurality of contexts are stored in the first context band, and wherein the controller is further configurable to:
in response to determining that the first context band does not have adequate space to store a new context, open a new context band and storing the new context in the new context band.

20. The computational device of claim 15, wherein boot time of the memory device is reduced by maintaining a context metadata that indicates a location of a latest context, in comparison to not maintaining the context metadata.

21. The computational device of claim 15, wherein endurance of the memory device is increased by storing a plurality of contexts in a single band in comparison to storing each context in a different band.

22. A computational device, comprising:
a processor;
a display communicatively coupled to the processor;
a network interface communicatively coupled to the processor; and
a memory device coupled to the processor, the memory device comprising:
a non-volatile memory; and
a controller coupled to the non-volatile memory, wherein the controller is configurable to:
store a first context starting from a first location of a band, and indicate in a metadata that the first context has been stored starting from the first location of the band; and
store a second context starting from a second location of the band and indicate in the metadata that the second context has been stored starting from the second location of the band.

23. The computational device of claim 22, wherein the controller is further configurable to:
in response to determining that a latest stored context has to be loaded, read the metadata to determine at which location of the band the latest stored context is stored; and
load the latest stored context from the location that is determined.

24. The computational device of claim 23, wherein the latest stored context is the second context.

25. The computational device of claim 22 wherein the first context comprises a volatile state information at a first instant of time, and wherein the second context comprises the volatile state information at a second instant of time.
